(19) United States
(12) Patent Application Publication
(10) Pub. No.: US 2026/0138454 A1
(43) Pub. Date: May 21, 2026

(54) Producing a Body Element

(71) Applicant: Bayerische Motoren Werke Aktiengesellschaft, Muenchen (DE)

(72) Inventors: Markus DIX, Kueps (DE); Joachim MELZIG, Landshut (DE); Rudolf SCHILLING, Ergolding (DE); Manuel SCHURZ, Landshut (DE); Karl-Heinz STUMP, Altdorf (DE)

(21) Appl. No.: 18/697,552

(22) PCT Filed: Oct. 10, 2022
(86) PCT No.: PCT/EP2022/078037

§ 371 Date: Apr. 1, 2024

(30) Foreign Application Priority Data
Nov. 8, 2021 (DE) 10 2021 128 937.8

(51) Int. Cl. B60K 37/10

(52) U.S. Cl. CPC B60K 37/10

(57) ABSTRACT

A method for producing a body element comprising the steps of: providing a hollow profile-shaped base body; arranging an attachment element on the base body; arranging a counter element in the base body; and, compressing the base body in order to fix the attachment element to the base body.

### BACKGROUND AND SUMMARY

This disclosure relates to a method for producing a body element, comprising the steps of providing a hollow profile-shaped main member; disposing an attachment element on the main member; and, compressing the main member in order to fix the attachment element to the main member. Furthermore, the disclosure relates to a body element produced in such a manner, and to a motor vehicle having such a body element.

Reducing a vehicle weight in order to reduce fuel and/or energy consumption is increasingly a priority in automotive engineering. Therefore, passenger motor vehicles are in most instances produced with an integral body. The advantages of the integral body include the lower weight due to the omission of the chassis, a higher level of impact safety, and better utilization of space. The body herein has to absorb all forces and momentums, this resulting in high demands in terms of safety technology.

Moreover, besides steel, materials such as aluminum, magnesium, or plastics materials are increasingly used in composite constructions so as to achieve further savings in weight. This is because the overall weight of a motor vehicle can be further reduced by using light materials and smart lightweight construction concepts, this resulting in savings in terms of fuel/energy and emissions, the environmental stress being reduced as a result.

Against this background, it is an object of the disclosure to improve a method for producing a body element. Such a method is in particular to be improved with a view to enabling flexibility in the basic design of body elements.

Specified according to a first aspect is a method for producing a body element, comprising the steps of: providing a hollow profile-shaped main member; disposing an attachment element on the main member; disposing a counter element in the main member; and, compressing the main member in order to fix the attachment element to the main member.

An in particular defined plastic deformation of the main member is caused by the compression. This deformation is blocked by the counter element, which is disposed within the hollow main member, so that the main member is forced to collapse outward. This can cause cross-sectional variation of the main member, as a result of which an in particular fixed clamping connection between the main member and the attachment element can be obtained. The main member and the attachment element are fixed to one another via the deformation caused.

A body element can be an in particular structural component of a body, thus of a superstructure of a motor vehicle, on a supporting chassis or on an integral body which is simultaneously the main frame of the vehicle.

A hollow profile-shaped main member has a wall which encloses an interior, and is in particular a hollow profile. The main member herein has a predetermined length, an inner cross section and an outer cross section, and a wall thickness. The main member herein can comprise steel or aluminum, or be configured from steel or aluminum.

The main member, in particular along its longitudinal extent, can have at least one curve, one offset, one angle, or one radius, and can be configured to be integral or assembled from at least two sub-elements. In order to meet different requirements, the main member can have cross sections and/or wall thickness that differ in size and/or shape across its longitudinal extent. In particular, the main member at each position is configured in such a manner that it meets stiffness requirements and is simultaneously configured to be optimized in terms of weight.

An attachment element is in particular a construction element or component of a functional group which is able to be disposed, or fastened, to the main member. For example, an attachment element can be a mounting element for further vehicle components such as interior and operating elements, or be a connecting element between two main members. The attachment element is disposed on an outer circumference of the main member, in particular at a predetermined position. For this purpose, the attachment element can have an attachment portion which is configured to at least partially encompass the main member in the cross-sectional direction. The attachment element can comprise steel, aluminum or in particular fiber-reinforced plastics material, or be configured from steel, aluminum or in particular fiber-reinforced plastics material.

A counter element is in particular a member that is disposed in the main member in order to form a counter bearing for the main member during compression, and to impede, or avoid, that the main member collapses in the direction of the counter element, thus toward the inside. An outer cross section of the counter element here can correspond to the inner cross section of the main member in such a manner that the counter element is able to be disposed, or placed, in the main member, in particular so as to be adjacent to the latter in an encircling manner. The counter element can have a predetermined stiffness in order to block, or avoid, that the main member is deformed, or buckled, in the direction of the counter element. The counter element herein can be configured to be elastically deformable so as to follow a deformation of the main member under the load applied by the compression, and to subsequently return to its original shape or geometry.

During compression, the main member can be exposed to an in particular predetermined compressive load, or compressive force, in particular substantially in its longitudinal direction, as a result of which the main member is imparted a change in its length, or a shortening of its length. The compression can in particular be a unilateral compression and be carried out via a suitable device. In the process, the main member can be imparted an in particular predetermined cross-sectional variation, wherein according to the disclosure this cross-sectional variation is a cross-sectional enlargement, because any inward deformation is counteracted via the counter element. In this way, the wall of the main member can deform, and in particular buckle, toward the outside. This deformation is blocked toward the inside by the counter element, and toward the outside by the attachment element disposed on the main member, as a result of which the wall of the main member, disposed in one or two region(s) adjacent to the attachment element, can be imparted a deformation in order for the attachment element to be clamped.

As a result of the production method proposed, changes in the microstructure and/or distortions of components that may arise in connection methods such as welding or other thermal joining methods can be avoided or prevented. Moreover, main members and attachment elements made of dissimilar materials can be connected so as to form a body element, as a result of which savings in weight owing to the use of light plastic attachment elements are possible. As a result of the reduction in weight of a motor vehicle having one or a plurality of body elements described herein, a fuel and/or energy consumption during operation can be reduced.

In one embodiment, the counter element is disposed in the region of the attachment element. The counter element herein is in particular configured in such a manner that it is able to be disposed in the main member, or is insertable into the cavity formed by the main member. The counter element is disposed so as to be opposite the attachment element, in particular in terms of the wall of the main member, in such a manner that the attachment element encompasses the main member and the counter element disposed therein. The counter element herein is in particular configured in such a manner, in terms of a longitudinal extent of the attachment element along the main member, that the counter element protrudes beyond the main member, in particular on both sides. In this way, the counter element can function as a counter bearing in both regions of the main member that are adjacent to the attachment element, so as to facilitate an in particular predetermined deformation of the main member in these regions.

In one embodiment the attachment element comes to in particular fixedly engage with the main member via in particular two radial, or circumferentially encircling, cross-sectional enlargements of the main member that are formed during compression. In other words, the attachment element is fixed by a first deformation, or cross-sectional enlargement, which is formed by the compression and is in particular axially adjacent to the attachment element, and a second deformation, or cross-sectional enlargement, which is opposite the first deformation and is in particular axially adjacent to the attachment element, the latter being in particular fixed therebetween.

This fixing can be configured in such a manner that mounting is effective in the axial direction of the main member and/or is effective in a circumferential direction of the main member. A fixed connection between the attachment element and the main member that can dispense with a thermal input, such as occurs during welding, for example, can be provided as a result. Changes in the microstructure and distortions of the components due to thermal reasons can be avoided as a result.

In one embodiment, the main member is compressed axially in relation to a longitudinal axis of the main member. As a result of axial compression, the compressive force to be applied can be introduced uniformly across the cross section of the main member, so as to cause a deformation, and thus a cross-sectional enlargement, that is as uniform as possible in an encircling manner. A deformation that is uniform in an encircling manner can be designed as a result, as a result of which stable fixing of the attachment to the main member in an encircling manner can be effected.

In one embodiment, the attachment element encloses the main member, in particular in an encircling manner. For this purpose, the attachment element in particular has a hollow-cylindrical attachment portion which is specified to be disposed on, or about, the main member. For example, this attachment portion can be configured to encompass the main member so as to rest on the latter in such a way that an encircling connection between the attachment element and the main member is possible. As a result of the attachment element encompassing the entire outer circumference of the main member, stable fixing of the attachment element to the main member via the compression-related deformation(s) is possible. In other embodiments, it can be expedient for the attachment element to partially encompass the main member, for example if a geometry of the main member does not permit the attachment element to be pushed on in the longitudinal direction and the attachment element therefore has to be pushed onto the main member laterally, or in the transverse direction, and for this purpose has an opening, in particular on an attachment portion.

In one embodiment, the main member is a tube. The tube herein can be a rotationally symmetrical tube, having an internal diameter, an external diameter, and a wall thickness. The tube herein can have dissimilar internal and/or external diameters across its longitudinal extent. In the case of a tube, a uniform deformation along the circumference of the main member is facilitated, as a result of which a uniform development of cross-sectional enlargements is enabled, and uniform clamping between the main member and the attachment element can thus be achieved.

In one embodiment, the counter element has a predetermined stiffness and/or predetermined malleability, hardness, elasticity, or breaking strength. The counter element herein has in particular an elastic deformation capability in order to enable a removal of the counter element from the main member after the deformation generated via the compression procedure. The counter element herein can comprise, or be formed from, an elastomer, in particular rubber, so as to be able to reassume its original shape after completing the change of shape on account of compression and/or elongation. Demolding and/or removal of the counter element can be facilitated as a result.

In one embodiment, the method comprises an additional step of removing the counter element. In the process, the counter element can be extracted from the main member via a retrieval device, for example via a rope, or a rod, which is in particular fastened to the counter element. As a result, the counter element can be re-used, on the one hand, and the original material properties and/or weight characteristics of the main member remain at least substantially unaffected, on the other hand.

Proposed according to a further aspect is a body element which is produced via a method described herein. The method described makes it possible to make available a body element made of a combination of different materials. For example, such a body element can have a metallic main member and at last one attachment element of a plastics material or composite material.

It is furthermore made possible to fix, or fasten, attachment elements of different materials and/or characteristics to the main member. In this way, it is possible to adapt the body element in a flexible manner to different requirements. Moreover, connections which have been generated by the method described herein can be released again, which can have a positive effect on any re-use or recycling of the individual components, or of the materials of the latter.

In one embodiment, the body element is a supporting tube, in particular a supporting tube for a dashboard of a motor vehicle. A supporting tube can be a crossmember for the dashboard of a motor vehicle, which can be disposed between the two A-pillars in the region below a windshield, for example. This supporting tube, or the attachment element(s) thereof, can be specified to fasten the dashboard. For this purpose, the attachment element or attachment elements can be configured as a mounting or mountings to which the dashboard and optionally further functional parts such as, for example, a central console and/or a steering device, can be fastened.

Supporting tubes of this type often have a profile cross section that is irregular across the length of the supporting tube, and are constructed from at least two portions which are disposed behind one another when viewed in the longitudinal direction of the supporting tube, so as achieve that the supporting tube is optimally adapted in the context of strength and weight optimization in the driver-side and passenger-side region.

Proposed according to a further aspect is a motor vehicle having at least one body element described herein. A motor vehicle of this type of configuration can combine the above-mentioned advantages, or utilize the latter.

### BRIEF DESCRIPTION OF THE DRAWINGS

Further advantages and potential applications of the disclosure are derived from the description hereunder in conjunction with the figures.

FIG. 1 shows a schematic illustration of a sequence of a method according to the disclosure for producing a body element; and,

FIGS. 2a) to 2c) show various exemplary embodiments of a body element, produced according to the disclosure, for a motor vehicle, in a schematic view.

### DETAILED DESCRIPTION OF THE DRAWINGS

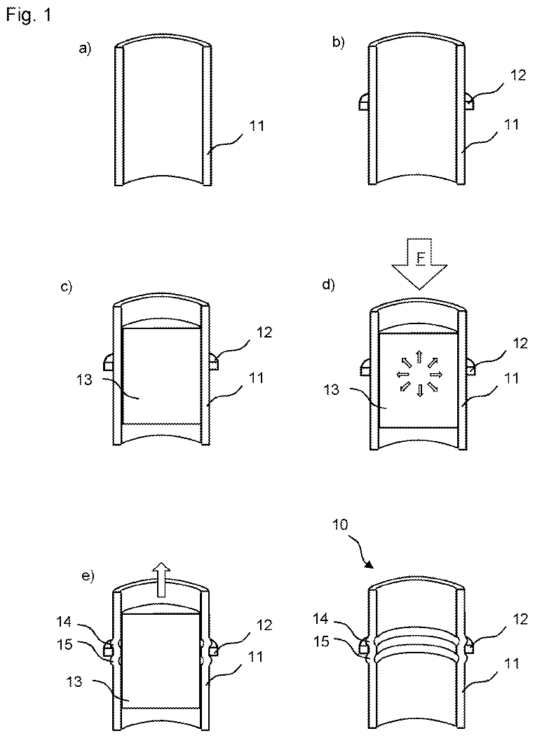

FIG. 1 shows steps a) to e) of a method 100 for producing a body element 10 according to a first exemplary embodiment, and a first exemplary embodiment of a body element 10 which has been produced via the method 100 disclosed herein, in a schematic sectional view.

In the illustration of FIG. 1, in a first step a), a hollow profile-shaped main member 11 in the form of a rotationally symmetrical tube is provided. In a further step b), an attachment element 12 is disposed about the main member. In the process, the attachment element 12, which encloses the tube 10, can be threaded onto the tube 11 from a free end, and be placed at a predetermined position.

In a further step c) a counter element 13 is disposed in the tube 11 so as to be in a region of the attachment element 12. The counter element 13 herein has a predetermined elasticity or stiffness in order to block inward collapsing of the tube wall, on the one hand, and to return to its original geometry after deformation, so as to be removable from the tube 11, on the other hand. The order of steps b) and c) can be reversed.

In a further step d) a compressive force F is exerted on the main member 11, in particular in its longitudinal direction, in order to compress the main member 11 and to in this way fix the attachment element 12 to the main member 11. The tube 11 is forced to deform as a result of the compression, whereby this deformation toward the inside of the tube is blocked by internal forces (symbolized by the array of arrows) of the counter element 13, this resulting in an outward cross-sectional variation of the tube wall. Two radial cross-sectional enlargements 14, 15 of the main member 11 are formed, via which the attachment element 12 fixedly engages with the main member 11.

In a further step e), the counter element 12 is removed from the tube 11 via an opening of the tube or hollow profile, this being indicated by an arrow. In this way, a body element 10, which is illustrated in the lowermost right portion of the image and has an attachment element 12 that is fixed via two mutually opposite cross-sectional enlargements 14, 15 of the tube 11, is made available.

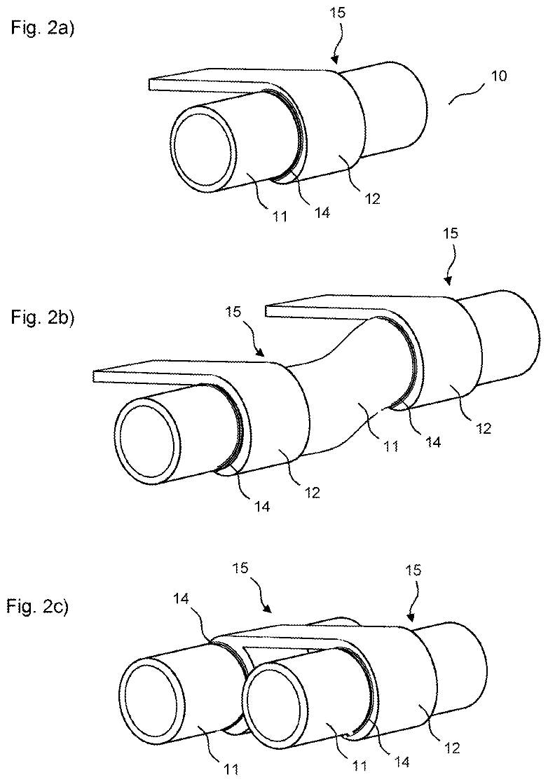

FIGS. 2a) to 2c) show various exemplary embodiments of a body element 10, produced according to the disclosure, for a motor vehicle.

FIG. 2a) shows a second exemplary element of a body element 10 having an attachment element 12 which in the longitudinal direction of the tubular main member 11 is fixed to the main member 11 on both sides via a first cross-sectional enlargement 14 and a second cross-sectional enlargement 15.

FIG. 2b) shows a third exemplary embodiment of a body element 10 having a first attachment element 12 and a second attachment element, which are in each case fixed to the main member 1 on both sides via a first cross-sectional enlargement 14 and a second cross-sectional enlargement 15. The main member 12 of this exemplary embodiment has an offset.

FIG. 2c) shows a fourth exemplary embodiment of a body element 10 having an attachment element 12 which connects a first main member 11 and a second main member 111 to one another. The attachment element 12 herein is in each case fixed to a tube 11 on both sides via a first cross-sectional enlargement 14 and a second cross-sectional enlargement 15.

List of reference signs

| | |
|---|---|
| 10 | Body element |
| 11 | Main member |
| 12 | Attachment element |
| 13 | Counter element |
| 14, 15 | Cross-sectional enlargement |
| a) to e) | Steps |

1.-11. (canceled)

12. A method for producing a body element comprising:
a) providing a hollow profile-shaped main member;
b) disposing an attachment element on the main member;
c) disposing a counter element in the main member; and,
d) compressing the main member in order to fix the attachment element to the main member.

13. The method according to claim 12, wherein the counter element is disposed in the region of the attachment element.

14. The method according to claim 12, wherein the attachment element comes to fixedly engage with the main member via radial cross-sectional enlargements of the latter that are formed during compression.

15. The method according to claim 12, wherein the main member is compressed axially in relation to a longitudinal axis of the main member.

16. The method according to claim 12, wherein the attachment element encloses the main member.

17. The method according to claim 12, wherein the main member is a tube.

18. The method according to claim 12, wherein the counter element has a predetermined stiffness.

19. The method according to claim 12, comprising:
e) removing the counter element.

20. A body element produced by the method according to claim 12.

21. The body element according to claim 20, wherein the body element is a supporting tube.

22. A motor vehicle having at least one body element according to claim 20.
